(19) United States
(12) Patent Application Publication
(10) Pub. No.: US 2019/0102790 A1
(43) Pub. Date: Apr. 4, 2019

(54) METHOD OF ECOMMERCE AD FRAUD PREVENTION

(71) Applicant: Marc Gregory Martino, Westlake Village, CA (US)

(72) Inventor: Marc Gregory Martino, Westlake Village, CA (US)

(21) Appl. No.: 16/148,862

(22) Filed: Oct. 1, 2018

Related U.S. Application Data
(60) Provisional application No. 62/565,102, filed on Sep. 29, 2017.

(51) Int. Cl. G06Q 30/02; H04L 29/06

(52) U.S. Cl. CPC G06Q 30/0248; H04L 63/104

(57) ABSTRACT

A method of reducing ad fraud for an Internet-based platform prevents advertising being shown to a user by any of the following steps: determining how many users of the plurality of users are associated with a particular IP address exceeding one or exceeding the number of authorized users; determining whether a screen of the user displaying the Internet-based platform is on, off or in screen saver mode; determining whether the Internet-based platform is currently being instantaneously displayed by the screen of the user; tracking a last time of a particular user input being a keyboard input, a mouse input or a touchscreen input which was made by the particular user; determining whether the user's electronic device has an accelerometer and whether a movement is occurring; determining whether the user's electronic device has a video camera and whether a movement is occurring in the electronic device from the video camera.

### CROSS-REFERENCE TO RELATED APPLICATIONS

This non-provisional application claims priority to provisional application 62/565,102 filed on Sep. 29, 2017, the entire contents of which are fully incorporated herein with this reference.

### DESCRIPTION

### Field of the Invention

The present invention relates to ad fraud on Internet-based platforms. More particularly, the present invention relates to ways to detect and prevent ad fraud by utilizing testing methods that only a human would be able to complete.

### BACKGROUND OF THE INVENTION

Ad fraud is rampant on the Internet, sucking up a company's advertising budget and in the process destroying that very business. Ad fraud is hard to stop because the nefarious computer programs (also called “bots”) mimic the actions of a real user. Millions of devices, whether they are mobile or desktop, can be infected with computer programs (bots) that operate in the background visiting websites pretending to be real potential customers. Furthermore, some nefarious actors can create a multitude of computers that are specifically focused to perpetuate such ad fraud, whether directed at an Internet-based platform itself or the end user. These bots are not real people and therefore no sales ever come from such fraudulent traffic. The inventor himself is the victim of ad fraud on Facebook® where now 98% of the paid traffic is fraudulent. Thus, this was the impetus for the inventor of finding a solution forward.

Google® has spent millions developing and perfecting various CAPTCHAs or reCAPTCHAs which are tests that are hard for bots to successfully complete. These tests can entail deciphering various hard to read scripts or deciphering visual tests that humans can pass but bots cannot. However, these tests have also become difficult for even people to pass and now the bots are sometimes better than these people at completing some of these tests. Google® is always trying to stay one step ahead of the bots, yet these solutions don't prevent Internet-Based Platforms (IBPs) (e.g. Yahoo®, Google®, Facebook®, LinkedIn®, SnapChat®, Instagram®, YouTube®, Pinterest®, Periscope®, Twitter®, reddit®, Quora®, Digg®, FlipBoard®, Yelp®, Zomato®, TripAdvisor®, WordPress®, Tumblr®, Medium®, Etsy®, Airbnb®, Uber®, Lyft®, Amazon®, Walmart®, etc.) from sending fraudulent traffic to an advertiser's website.

For example, an advertiser may use the Facebook® IBP to run ads to drive traffic to their business website. Each time a person sees an ad on Facebook® and then clicks to visit the advertiser's website, the advertiser is charged for this click. However, what happens if the click was not a real person, but a fake click generated by a nefarious actor or a nefarious computer program? The advertiser is charged but never sells a single item because all (or a percentage) of the traffic is not real people. This is ad fraud and can quickly destroy a business.

Accordingly, a new solution is needed for IBPs to overcome this ad fraud such that IBPs can offer ads to their advertisers without those clicks becoming fraudulent clicks.

### SUMMARY OF THE INVENTION

An exemplary embodiment of the present invention is a method of preventing and/or reducing ad fraud in ecommerce over the Internet, the method comprising the steps of: creating an Internet-based platform having a plurality of users engaging with the Internet-based platform on each user's electronic device, the Internet-based platform selling advertising to an advertiser, the advertising to be displayed by each user's electronic device when using the Internet-based platform; and preventing the advertising from being sent to a particular user from the plurality of users when an ad fraud is detected for the particular user.

The ad fraud may comprise any of the following steps individually or in combination for further detection and improved accuracy:

1) determining how many users of the plurality of users are associated with a particular IP address; determining ad fraud when the number of users on the particular IP address exceeds 1;
2) determining how many users of the plurality of users are associated with a particular IP address; wherein when the number of users on the particular IP address exceeds 1 (one), determining whether these additional users are authorized users by asking the user for verification via a text, email, phone call or question sent through the Internet-based platform; determining ad fraud when the number of unauthorized users exceeds the number of authorized users;
3) determining whether a screen of the user displaying the Internet-based platform is on or off; determining ad fraud when the screen is off;
4) determining whether a screen of the user is displaying the screen saver mode; determining ad fraud when the screen saver mode is activated;
5) determining whether the Internet-based platform is currently being instantaneously displayed by the screen of the user; determining ad fraud when the Internet-based platform is not being instantaneously displayed to the screen;
6) tracking a last time of a particular user input being a keyboard input, a mouse input or a touchscreen input which was made by the particular user; establishing a set period of elapsed time to start from the last input of the particular user; determining ad fraud when the last time of a particular user input exceeds the set period of elapsed time;
7) determining whether the user's electronic device has an accelerometer; and if so, determining whether a movement is occurring in the electronic device from the accelerometer; determining ad fraud when the movement is not occurring; and/or
8) determining whether the user's electronic device has a video camera; and if so, determining whether a movement is occurring in the electronic device from the video camera; determining ad fraud when the movement is not occurring.

### DETAILED DESCRIPTION OF THE PREFERRED EMBODIMENTS

The solution is to use the physical characteristics that only a real human would be able to mimic such that a bot could never achieve. Furthermore, a multitier approach could be used that had varying levels of security checks that the bot would have a practically impossible time of achieving. Many of these safety checks could be running in the background such that the real human user would not even notice it and therefore not disrupt their user experience on the IBP.

The first level of protection is for the IBP that sells ads for advertisers to determine how many user sessions are coming from a particular IP address. Typically a single user will be on a single IP (Internet protocol) address. Thus, this means that one user sessions will be associated with the one IP address. In the case where two devices are using one IP address, such as a smart tablet using the internet from a smart phone which is acting as a hub, both devices can be authorized by the user. The IBP can detect that two devices are under one IP address and send a confirmation email, text, phone call or question through the IBP to the user such that the user can verify both devices are valid. Accordingly, when a bot may be running in the background and if the IBP can detect more than one session that is unauthorized coming from an IP address it means it is likely that there is a bot and therefore an ad will not be sent to such user. For example, a smart phone has a particular IP address. If the IBP has two open sessions running at the same time from a single IP address it is impossible that this is just one person. Therefore, this particular IP can be placed into a category where ads will not be shown to anyone on this IP address.

Sometimes a real user may be using a portable electronic device (e.g. a smart phone) and has placed the smart phone down which means if a bot is operating IBP, it would be the only user accessing that particular IP address. Or a bot may be operating behind the scene on a person's desktop computer when the person is not using the desktop computer. Therefore, the next level of protection would be to allow the IBP to access whether the screen was on. If the screen is not displaying information, either being in sleep mode or screen saver mode, then the access is from a bot as the user cannot be a real person if they are not seeing the screen. The IBP can then deny access to the bot at this point or again place the IP address into a category where ads will not be shown.

Even when a person is viewing the screen, the IBP may not be the information that is being currently displayed. For example, the IBP may still be operating in the background when other programs are being displayed to the screen instead. Therefore, ads should not be shown to users when the IBP is not being directly/instantaneously displayed to the screen.

A real human using a computer, whether desktop or mobile, is usually interacting with the keyboard, mouse or touch screen in a repeated and consistent manner, meaning it is very rare when using an Internet-based program that the person will not enter a key stroke or touch the screen for some period of time, say 5, 10, 15, 30 or 60 seconds. Usually, the only time a user is not touching a keypad, mouse or touch screen is when the user is watching a video. And even when the user is watching a video, this is not the time that an ad should be sent. Therefore, if the IBP is operating, and the user has not made a user input for some period of elapsed time, the IBP may be being accessed by the ad fraud. Accordingly, advertising should not be sent to the user if a set period of elapsed time has elapsed without a keystroke, mouse movement or touch screen movement.

Most mobile devices today have at least one accelerometer. These accelerometers are used for a variety of purposes. Likewise, the IBP can also be granted access to the accelerometers on each device. Even a very still and sedentary user does actually move the smart device just enough all the time such that the smart phone can determine if it is being held and in use. If there is a bot that is accessing the IBP and there is no changing accelerometer data then this means it is indeed ad fraud accessing the information and the advertising can be stopped.

Most smart phones have cameras located on the same side as the screen, or traditionally even opposite the screen. The IBP can gain access to a video camera to make sure motion is being detected. Again, a user holding a phone does have a small amount of video movement that can be detected by the video camera. If there is no video movement then this means it is indeed ad fraud and the advertising can be shut down. Movement can easily be discerned when one frame does not match the next frame from the video input, especially over a period of time. For example, even a person trying to hold a phone steady will make small movements that can be picked up by the video camera. Therefore, it is easy for a programmer to discern movement solely from the video camera feed itself.

The camera can also be used with facial recognition software to recognize a particular user who has registered with the IBP. For example, the IBP can register the person's facial characteristics such that they can determine whether access is from a real person or from a bot.

The IBP can also record various facial expressions as the user views the content in the media platform. A human would react to various stimuli on a repeatable level that can be tracked. For instance, various videos or pictures can track a baseline user's facial expressions and then compare them with actual users. If the users expressions are not consistent with the expected expressions than that user could be placed into a category where ads will not be shown to them. In other words, based on facial expressions a IBP can allocate users into various risk pools such that then advertisers can choose whether they want verified real users or want to risk their ads being shown to riskier demographics that might include bot traffic.

The IBP can also ask the user to perform various tests that the bot would never be able to do. For example, the IBP can query suspicious sessions and ask the user to verify they are not a bot by shaking the phone (accelerometer or video determined), opening their mouth (video determined), raising their eyebrows (video determined) or pointing the smart phone downward or upwards (accelerometer or video determined). A bot or fraudulent computer program would not be able to manipulate the smart phone (mobile device) to perform such actions.

Any one of the mentioned safety checks could be used alone or in combination with other safety checks. As is appreciated with those skilled in the art, the use of mobile devices allows solutions that desktop computers may not already have, such as access to the cameras and accelerometers.

All of the solutions described herein would be implemented with software as is known in the industry. It is within the ability of those skilled in the art to devise such safety checks on a variety of IBP with a variety of different software. Therefore, in this patent application no particular code is necessary to be displayed herein for one skilled in the art to understand the present invention.

What is claimed is:

1. A method of preventing and/or reducing ad fraud in ecommerce over the Internet, the method comprising the steps of:
creating an Internet-based platform having a plurality of users engaging with the Internet-based platform on each user's electronic device, the Internet-based platform selling advertising to an advertiser, the advertising to be displayed by each user's electronic device when using the Internet-based platform;
preventing the advertising from being sent to a particular user from the plurality of users when an ad fraud is detected for the particular user;
the ad fraud comprising any of the following steps:
1) determining how many users of the plurality of users are associated with a particular IP address; determining ad fraud when the number of users on the particular IP address exceeds 1;
2) determining how many users of the plurality of users are associated with a particular IP address; wherein when the number of users on the particular IP address exceeds 1, determining whether these additional users are authorized users by asking the user for verification via a text, email, phone call or question sent through the Internet-based platform; determining ad fraud when the number of unauthorized users exceeds the number of authorized users;
3) determining whether a screen of the user displaying the Internet-based platform is on or off; determining ad fraud when the screen is off;
4) determining whether a screen of the user is displaying the screen saver mode; determining ad fraud when the screen saver mode is activated;
5) determining whether the Internet-based platform is currently being instantaneously displayed by the screen of the user; determining ad fraud when the Internet-based platform is not being instantaneously displayed to the screen;
6) tracking a last time of a particular user input being a keyboard input, a mouse input or a touchscreen input which was made by the particular user; establishing a set period of elapsed time to start from the last input of the particular user; determining ad fraud when the last time of a particular user input exceeds the set period of elapsed time;
7) determining whether the user's electronic device has an accelerometer; and if so, determining whether a movement is occurring in the user's electronic device from the accelerometer; determining ad fraud when the movement is not occurring; and/or
8) determining whether the user's electronic device has a video camera;
and if so, determining whether a movement is occurring in the user's electronic device from the video camera; determining ad fraud when the movement is not occurring.

2. A method of preventing and/or reducing ad fraud in ecommerce over the Internet, the method comprising the steps of:
creating an Internet-based platform having a plurality of users engaging with the Internet-based platform on each user's mobile electronic device, the Internet-based platform selling advertising to an advertiser, the advertising to be displayed by each user's mobile electronic device when using the Internet-based platform;
preventing the advertising from being sent to a particular user from the plurality of users when an ad fraud is detected for the particular user;
the ad fraud comprising any of the following steps:
1) determining whether a screen of the user displaying the Internet-based platform is on or off; determining ad fraud when the screen is off;
2) determining whether the Internet-based platform is currently being instantaneously displayed by the screen of the user; determining ad fraud when the Internet-based platform is not being instantaneously displayed to the screen;
3) tracking a last time of a particular user input being a keyboard input, a mouse input or a touchscreen input which was made by the particular user; establishing a set period of elapsed time to start from the last input of the particular user; determining ad fraud when the last time of a particular user input exceeds the set period of elapsed time;
4) determining whether the user's mobile electronic device has an accelerometer; and if so, determining whether a movement is occurring in the user's mobile electronic device from the accelerometer; determining ad fraud when the movement is not occurring; and/or
5) determining whether the user's mobile electronic device has a video camera; and if so, determining whether a movement is occurring in the user's mobile electronic device from the video camera; determining ad fraud when the movement is not occurring.

3. A method of preventing and/or reducing ad fraud in ecommerce over the Internet, the method comprising the steps of:
creating an Internet-based platform having a plurality of users engaging with the Internet-based platform on each user's mobile electronic device, the Internet-based platform selling advertising to an advertiser, the advertising to be displayed by each user's mobile electronic device when using the Internet-based platform;
preventing the advertising from being sent to a particular user from the plurality of users when an ad fraud is detected for the particular user;
the ad fraud comprising each of the following steps in any order:
1) determining whether the Internet-based platform is currently being instantaneously displayed by the screen of the user; determining ad fraud when the Internet-based platform is not being instantaneously displayed to the screen;
2) tracking a last time of a particular user input being a keyboard input, a mouse input or a touchscreen input which was made by the particular user; establishing a set period of elapsed time to start from the last input of the particular user; determining ad fraud when the last time of a particular user input exceeds the set period of elapsed time; and
3) determining whether the user's mobile electronic device has an accelerometer; and if so, determining whether a movement is occurring in the user's mobile electronic device from the accelerometer; determining ad fraud when the movement is not occurring.
